(19) United States
(12) Patent Application Publication
(10) Pub. No.: US 2006/0033989 A1
(43) Pub. Date: Feb. 16, 2006

(54) Methods for hyperspace diagonal counting for multiobjective pareto frontier visualization and systems thereof

(76) Inventors: Kevin Chugh, Amherst, NY (US); Christina Bloebaum, Getzville, NY (US); Gautam Agrawal, Amherst, NY (US); Kemper Lewis, East Amherst, NY (US); Chen-Hung Huang, Tonawanda, NY (US); Sumeet Parashar, Amherst, NY (US)

Correspondence Address: Gunnar G. Leinberg, Esq.;Nixon Peabody LLP, Clinton Square, P.O. Box 31051, Rochester, NY, 14603-1051, US

(21) Appl. No.: 11/203,903

(22) Filed: Aug. 15, 2005

Related U.S. Application Data
(60) Provisional application No. 60/601,421, filed on Aug. 13, 2004.

(51) Int. Cl. G02B 21/06

(52) U.S. Cl. 359/385

(57) ABSTRACT

A method and system for visually representing a Pareto frontier includes performing two or more optimizations from different initial points to obtain optimal values for each of two or more objective functions. A minimum value and a maximum value are identified from the optimal values for each of the objective functions to establish a range for each of the objective functions. Each of the ranges is divided into a first number of bins for each of the objective functions and a determination is made about which of the objective functions will be placed on which of at least two axes. Indices of the bins are plotted along the determined of the at least two axes for each of the objective functions. The plotted indices represent the Pareto frontier for the objective functions along the at least two axes are output.

This application claims the benefit of U.S. Provisional Patent Application Ser. No. 60/601,421, filed Aug. 13, 2004, which is herein incorporated by reference in its entirety.

### FIELD OF THE INVENTION

This invention generally relates to methods and systems for visualizing multidimensional relationships and, more particularly, to methods for hyperspace diagonal counting for multiobjective Pareto frontier visualization and systems thereof.

### BACKGROUND

The concept of Pareto optimality has been widely used in many industries to aid designers in their decision-making process when faced with multiple objective functions. In a case wherein multiple objective functions exist in an optimal design problem formulation (e.g. minimize weight, maximize efficiency, etc.), an infinite number of optimal solutions is possible, forming what is known as the Pareto frontier. Along this frontier (a line or curve for two objective functions, a surface for three objective functions, a hyper-surface for four or more objective functions), is the set of non-dominated points in the performance space wherein no one objective function can improve without further increasing others. The determination as to which of these resulting optimal solutions is to be picked for the subsequent product design is dependent upon preferences of the designer. The decision-maker applies his preferences once he has data of the Pareto frontier associated with the multiobjective design problem being addressed.

Currently there is no way to visualize in three dimensions a multidimensional data set. The only solutions to the problem that exist can be categorized in two ways: enhanced geometry; and dimension reduction. Enhanced geometry visualization techniques show dimensions in visual ways other than three-dimensional geometry.

For example, there have been techniques that employ attributes like color to visualize one of the dimensions. In this approach, three of the dimensions are represented visually (as points, or curves, for example), and the remainder are visualized as attributes (color, etc.). This approach allows for few dimensions to be visualized beyond three, as the representation quickly becomes confusing.

Dimension reduction techniques visualize subsets of the dimensions visually. This is accomplished by fixing several of the dimensions and visualizing other dimensions. This requires multiple visualizations to get a full picture of the data, and is unreasonable for large dimension data sets (100+dimensions). Dimension reduction often results in a loss of meaning, a loss of the concept of a neighborhood, or a loss of an ability to understand the representation in an intuitive way.

### SUMMARY

A method for visually representing a Pareto frontier in accordance with embodiments of the present invention includes performing two or more optimizations from different initial points to obtain optimal values for each of two or more objective functions. A minimum value and a maximum value are identified from the optimal values for each of the objective functions to establish a range for each of the objective functions. Each of the ranges is divided into a first number of bins for each of the objective functions and a determination is made about which of the objective functions will be placed on which of at least two axes. Indices of the bins are plotted along the determined of the at least two axes for each of the objective functions. The plotted indices represent the Pareto frontier for the objective functions along the at least two axes are output.

A system for visually representing a Pareto frontier in accordance with embodiments of the present invention includes an optimization system, an identification system, a dividing system, a determination system, a plotting system, and an output device in one or more computing devices. The optimization system performs two or more optimizations from different initial points to obtain optimal values for each of two or more objective functions. The identification system identifies a minimum value and a maximum value from the optimal values for each of the objective functions to establish a range for each of the objective functions. The dividing system divides each of the ranges into a first number of bins for each of the objective functions. The determination system determines which of the objective functions will be placed on which of at least two axes. The plotting system plots indices of the bins along the determined one of the at least two axes axis for each of the objective functions. The output device outputs the plotted indices which represent the Pareto frontier for the objective functions along the at least two axes.

A method for visually non-dominated points representing a Pareto frontier in accordance with embodiments of the present invention includes discretizing a design space for a first number of divisions along a plurality of design variables to form a grid. Each point in the grid is analyzed in an n dimensional space to provide a value for each of a plurality of objective functions. A minimum value and a maximum value are identified from the optimal values for each of the objective functions to establish a range for each of the objective functions. Each of the ranges is divided into a first number of bins for each of the objective functions and a determination is made about which of the objective functions will be placed on which of at least two axes. Indices of the bins are plotted along the determined of the at least two axes for each of the objective functions. The plotted indices represent non-dominated points which represent a Pareto frontier for the objective functions along the at least two axes.

A system for visually representing a Pareto frontier in accordance with embodiments of the present invention includes a discretizing system, an analysis system, an identification system, a dividing system, a determination system, a plotting system, and an output device in one or more computing devices. The discretizing system discretizes a design space for a first number of divisions along a plurality of design variables to form a grid. The analysis system analyzes each point in the grid in n dimensional space to provide a value for each of a plurality of objective functions. The identification system identifies a minimum value and a maximum value from the optimal values for each of the objective functions to establish a range for each of the objective functions. The dividing system divides each of the ranges into a first number of bins for each of the objective functions. The determination system determines which of the objective functions will be placed on which of at least two axes. The plotting system plots indices of the bins along the determined one of the at least two axes axis for each of the objective functions. The output devices outputs the plotted indices which represent the Pareto frontier for the objective functions along the at least two axes.

The present invention provides a method and system to visualize the Pareto frontier for n-objective problems in an intuitive way. With the present invention, massive datasets with ultra-high dimensionality (100+dimensions) can be easily and intuitively represented. The present invention uses a new technique of ‘lossless’ dimension blending, termed the Hyper-Space Diagonal Counting (HSDC) method. The present invention not only provides a unique and intuitive way to visually represent the n-dimensional (n objective functions) Pareto points generated through any existing optimization routines, but it also provides a quick and simple way to sample design points in n-objective performance space for non-dominated points and visually represent them in an intuitive way.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a block diagram of a system for hyperspace diagonal counting in accordance with embodiments of the present invention;

FIG. 2A is a graph of an array of ordered pairs of positive integers;

FIG. 2B is a graph of a path through the array of ordered pairs shown in FIG. 2A;

FIG. 3 is a graph of a path for counting in three dimensional space;

FIG. 4 is a graph of a bi-objective plot on the X-axis and the Y-axis;

FIG. 5 is a graph of a parallel coordinate plot;

FIG. 6A is a two dimensional graph of an objective function F, bin on an X-axis and an objective function F₂ bin on a Y-axis with twenty along each objective;

FIG. 6B is a three dimensional graph with non-dominated or Pareto points along Z-axis;

FIG. 7A is two dimensional graph of an objective function F₁ bin an X-axis with fifty along each objective;

FIG. 7B is a three dimensional graph with non-dominated or Pareto points along a Z-axis;

FIG. 8 is a two dimensional graph with an objective function F₁ bin on an X-axis and an objective function F₂ bin on a Y-axis showing Pareto points and non-dominated points;

FIG. 9A is a two dimensional graph of objective functions F₁ F₂ bins on an X-axis and objective functions F₃ F₄ bins on Y-axis, with a grid of fifteen for all four objective functions;

FIG. 9B is three dimensional graph with non-dominated or Pareto points along a Z-axis;

FIG. 10A is a two dimensional graph of objective functions F₁ F₂ bins on an X-axis and objective functions F₃ F₄ bins on a Y-axis with a grid of twenty for all four objective functions; and

FIG. 10B is a three dimensional graph with non-dominated or Pareto points on a Z-axis.

### DETAILED DESCRIPTION

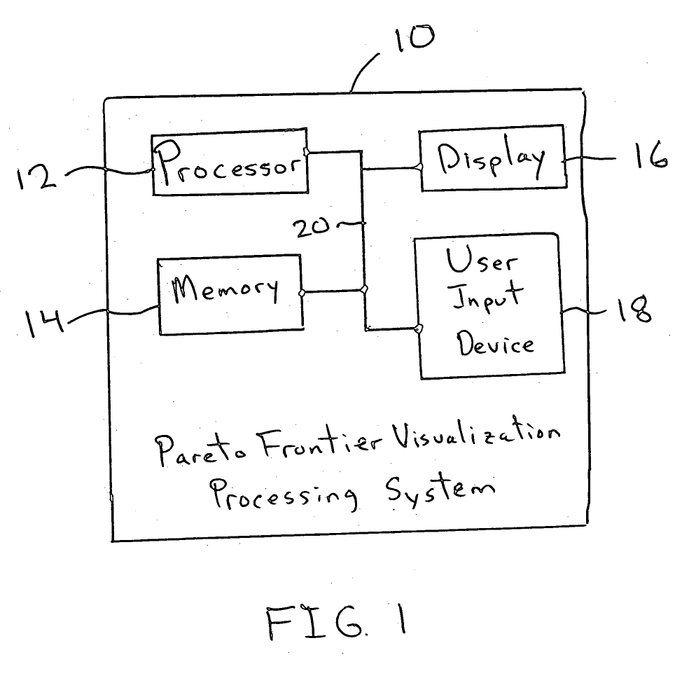

A system 10 for hyperspace diagonal counting for multiobjective pareto frontier visualization in accordance with embodiments of the present invention is illustrated in FIG. 1. The present invention provides a method and system to visualize the Pareto frontier for n-objective problems in an intuitive way. The present invention also provides a quick and simple way to sample design points in n-objective performance space for non-dominated points and visually represent them in an intuitive way.

Referring to FIG. 1, the Pareto frontier visualization processing system 10 comprises a central processing unit (CPU) or processor 12, a memory 14, a display 16, and a user input device 18 which are coupled together by a bus or other link 20, although other numbers and types of components in other configurations and other types of systems could be used. The processor 12 executes a program of stored instructions for multiobjective Pareto frontier visualization as described and illustrated in the embodiments herein. The memory 14 stores these programmed instructions for execution by the processor 12. A variety of different types and numbers of memory storage devices, such as a random access memory (RAM) or a read only memory (ROM) in the system or a floppy disk, hard disk, CD ROM, or other computer readable medium which is read from and/or written to by a magnetic, optical, or other reading and/or writing system that is/are coupled to the processor 12, could be used for the memory 14 to store these programmed instructions. The display 16 comprises a computer monitor which displays information to the operator, such as input data or parameters or the determined Pareto frontier visualization, although other numbers and types of displays could be used. The user input device 18 comprises a keyboard to enter data into the Pareto frontier visualization system 10, although other numbers and types of user input devices could be used, such as a computer mouse.

Although described and illustrated herein as implemented in a Pareto frontier visualization processing system 10, the methods and systems of the present invention may be implemented on any suitable computer system or computing device. For example, the present invention may be implemented on one or more workstations, PCs, laptop computers, PDAs, handheld devices, cellular telephones, wireless devices, other computerized devices, and the like. It is to be understood that the devices and systems of the exemplary embodiments are for exemplary purposes, as many variations of the specific hardware used to implement the exemplary embodiments are possible, as will be appreciated by those skilled in the relevant art(s).

Furthermore, the methods and systems of the present invention may be conveniently implemented using one or more general purpose computer systems, microprocessors, digital signal processors, micro-controllers, and the like, programmed according to the teachings of the present invention as described and illustrated herein, as will be appreciated by those skilled in the computer and software arts.

In addition, two or more computing systems or devices can be substituted for any one of the devices and systems in any embodiment of the present invention. Accordingly, principles and advantages of distributed processing, such as redundancy, replication, and the like, also can be implemented, as desired, to increase the robustness and performance the devices and systems of the exemplary embodiments. The present invention may also be implemented on computer systems that extend across any network using any suitable interface mechanisms and communications technologies including, for example, telecommunications in any suitable form (e.g., voice, modem, and the like), wireless communications media, wireless communications networks, cellular communications networks, G3 communications networks, Public Switched Telephone Network (PSTNs), Packet Data Networks (PDNs), the Internet, intranets, a combination thereof, and the like.

The present invention may also be embodied as a computer readable medium having instructions stored thereon for generating a model for simulating systems of reacting species, which when executed by a processor, cause the processor to carry out the steps necessary to implement the methods of the present invention. The computer readable medium may also include programmed instructions for carrying out any of the other steps described and illustrated herein with respect to the methods of the present invention.

As recognized by Georg Ferdinand Ludwig Philipp Cantor (“Cantor”), every point on a surface has a corresponding point on a line, and vice versa. The result of this observation is that there is a one to one correspondence of points on the interval [0, 1] and points in an n-dimensional space. This set theory rests upon a very simple idea—that even though you may not be able to count something, you can equate it with something else that has the same cardinality (i.e. the same number of elements). Accordingly, even though an infinite set can not be enumerated, its cardinality could be determined, or at least equated to that of another set. Two infinite sets can be shown to have the same cardinality, by finding a one-to-one mapping between the elements of each set. Cantor's theorem for mapping points in a two-dimensional space on a line can be written:

$$\vert N \vert = \vert {N}^{2} \vert Where , \begin{matrix}N = \{ 1 , 2 , 3 , 4 , … \} \\ {N}^{2} = \{ ordered pairs of members of N \}\end{matrix}$$

The cardinality of N, or |N|, is denoted as N₀ (the meta-letter aleph-zero or aleph-null), which is equal to the cardinality of the integers.

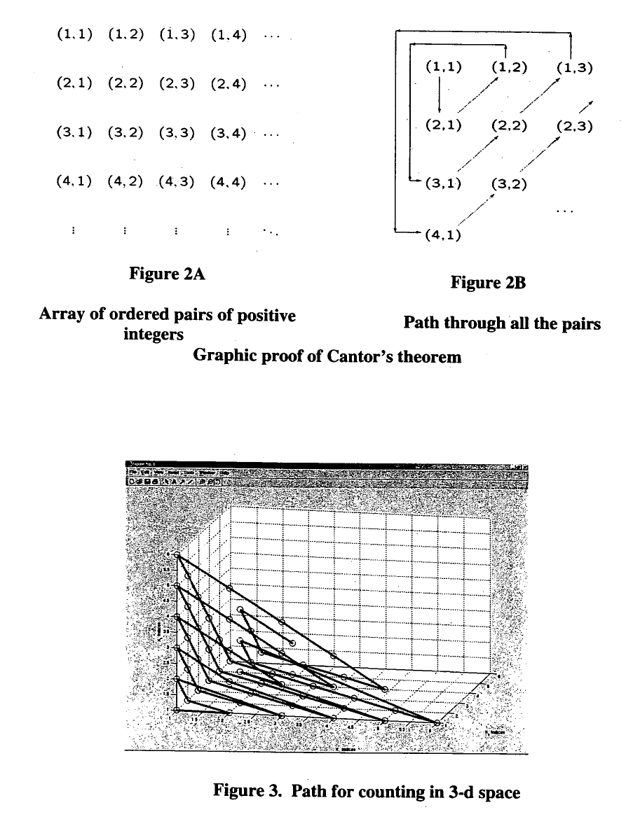

Referring to FIGS. 2A and 2B, diagrams of the proof of Cantor's theorem for N² are illustrated. Consider an array that includes all the ordered pairs of positive integers and then make a path through all the pairs in the way shown. In this way, every single element of set N² can be mapped to one (and only one) element of set N (i.e. the cardinality of set N is same as that of set N²). Hence, for every point on a two-dimensional surface there is a corresponding point on a line, which is unique.

This concept of counting is important to understand a process of Hyper-Space Diagonal Counting (HSDC) used in the present invention to achieve lossless dimension blending for multidimensional viewing. Accordingly, an extension of Cantor's theorem and an example of HSDC in accordance with the present invention to show a mapping for three-dimensional points is illustrated in FIG. 3.

The present invention enables mapping points in an n-dimensional space to a line. This mapping can be described by:

$$\vert N \vert = \vert {N}^{2} \vert = \vert {N}^{3} \vert = \vert {N}^{3} \vert … = \vert {N}^{ n} \vert = {0}_{}$$

$$Where , \begin{matrix}N = \{ 1 , 2 , 3 , 4 , … \} \\ {N}^{n} = \{ {n}^{th} ordered combinations of all members of N \}\end{matrix}$$

The present invention makes an array of n^{th} ordered combinations of all the members of Nⁿ and then creates a path through all the points to get a sequence.

To further understand HSDC it will be helpful to define several terms. The variable n is used to denote the number of dimensions, l is used to represent the level on which a particular point falls (i.e. which loop out from the origin), Eₗ is the number of elements (i.e. points) on a particular level, Cᵢ is the counting index associated with element i (point i), and TEⁿₗ are the total number of elements up to level l.

Five equations must be developed in order to be able to automate HSDC in any multidimensional space. For these equations, it is necessary to know: 1) the total number of elements at a particular level; 2) the total elements up to a particular level; 3) the elements at a particular level in terms of the elements of the previous level; 4) the total number of elements up to a level in terms of the elements in that level; and 5) what counting indices will correspond to a particular level. The first four equations and the fifth formula have been developed as follows:

$$\begin{matrix}{E}_{l}^{n} = \{ \begin{matrix}\frac{( {\prod }_{k = 0}^{k = n - 2} ( l + k ) )}{( n - 1 ) !} & n \neq 1 \\ \frac{1}{( n - 1 ) !} & n = 1\end{matrix} & ( 1 ) \\ {TE}_{l}^{n} = {\sum }_{1}^{l} {E}_{l}^{n} & ( 2 ) \\ {E}_{l + 1}^{n} = ( \frac{l + n - 1}{l} ) {E}_{l}^{n} & ( 3 ) \\ {TE}_{l}^{n} = ( \frac{n + l - 1}{n} ) {E}_{l}^{n} & ( 4 )\end{matrix}$$

The final formula is expressed in terms of an inequality as:

$${C}_{i} \leq \frac{( l + n - 1 ) !}{( l - 1 ) ! ( n ) !} \qquad ( 5 )$$

The fifth formula is an (n−1)^{th} order polynomial inequality, which must be solved in constant time in order to automatically generate any combination of variables for any size multidimensional problem. Alternatively, an optimization routine or similar technique could be used in a preprocessing mode.

HSDC can now be applied to a multidimensional visualization of performance space in multiobjective optimization. By way of example only, consider a test problem with two objective functions, four design variables, and two inequality constraints, in which the objective functions are competitive and they are each to be minimized.

$$Minimize : \\ \begin{matrix}{f}_{1} = 2 + {( {X}_{1} - 7 )}^{2} + {( \frac{{X}_{2}}{2} - 6 )}^{2} - 3 {X}_{3} + {( {X}_{4} - 5 )}^{2} \\ {f}_{2} = - 10 {X}_{1} - {X}_{2} + 2 {( {X}_{3} - 7 )}^{2} - 5 {X}_{4}\end{matrix}$$

$$Subjected to : \\ \begin{matrix}{g}_{1} = \frac{( {( {X}_{1} - 5 )}^{2} + {( {X}_{3} - 2 )}^{2} - 75 )}{75} \leq 0 \\ {g}_{2} = \frac{( 2 {X}_{1} + 2 {X}_{2} + 2 {X}_{3} + {X}_{4} - 70 )}{70} \leq 0 \\ Where : 0 \leq {X}_{i} \leq 20\end{matrix}$$

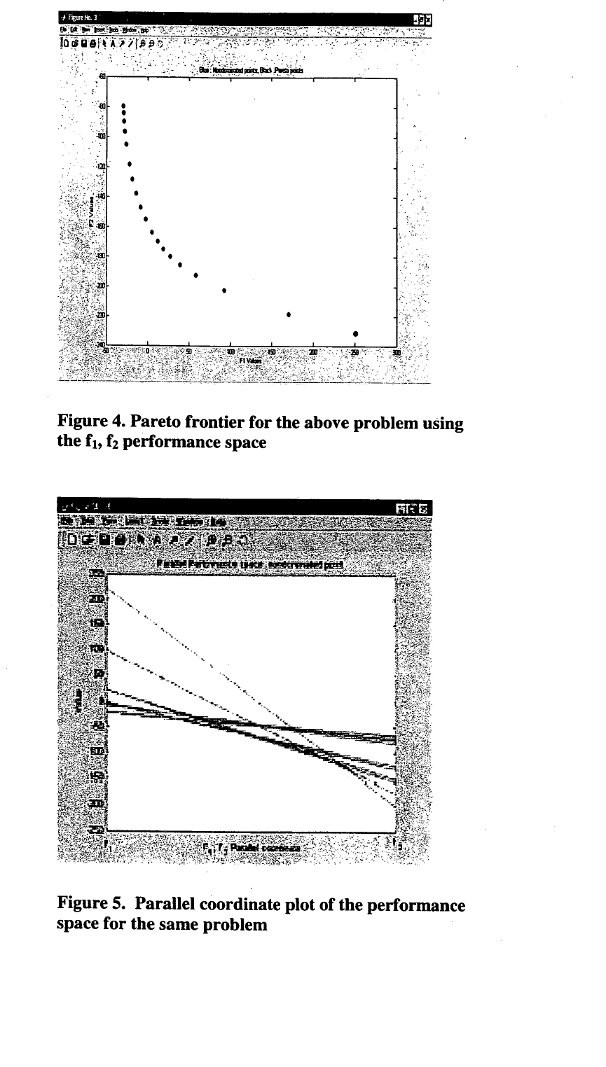

Traditional approaches to visualize the Pareto frontier for the above problem could be a bi-objective function plot on the XY axes as shown in FIG. 4 or the parallel coordinate plot as in FIG. 5. Both these methods are incredibly useful, but they have their own limitations. For example, with these traditional approaches the Pareto frontier can be plotted for up to only three objective functions. Using parallel coordinates theoretically there can be as many objective functions as desired, on parallel axes, but for really large problems space will soon run out. Moreover, it is not very intuitive.

The present invention can easily map n dimensions to a line. As a result, the counting scheme, HSDC, can be used to map any number objective functions to a single line in order to generate the visual representation of the Pareto frontier for more than three objective function problems. To accomplish this with the present invention, the counting scheme, HSDC, has to be assisted by a simple, but very significant binning technique which is described in greater detail in the exemplary embodiments below.

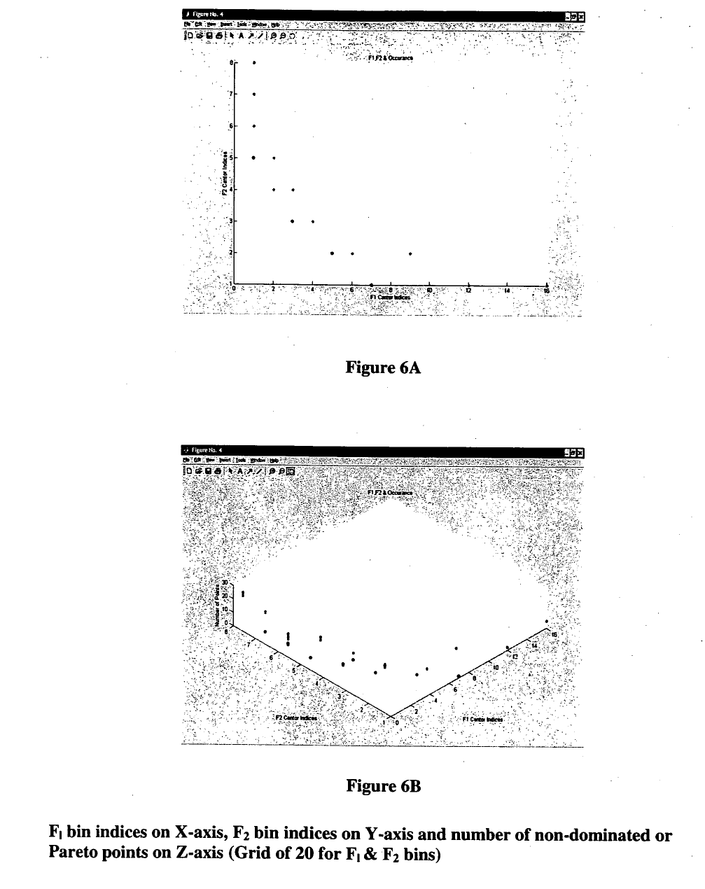

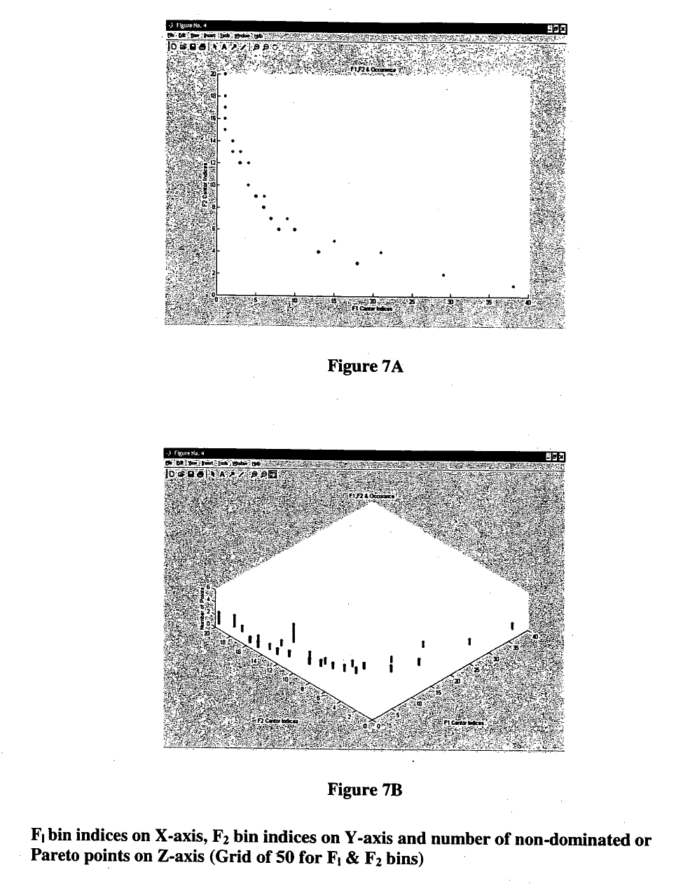

A method for visualization of non-dominated points in accordance with embodiments of the present invention will now be described below with reference to FIGS. 6A, 6B, 7A. 7B, and 8. This method pertains to visualizing an approximation of the Pareto frontier through representation of non-dominated points obtained from a discretization and subsequent analysis in the design space.

The Pareto frontier visualization processing system 10 discretizes the design space for some finite number of divisions along all the dimensions, i.e. design variables, to form a grid. An analysis for each grid point in the n dimensional space is performed by the Pareto frontier visualization processing system 10 and the result of performing this analysis is a value for each of the objective functions and constraints, for problems with constraints.

The Pareto frontier visualization processing system 10 identifies the minimum and maximum values for each of the objective functions to establish a range. These ranges are divided by the Pareto frontier visualization processing system 10 into some finite number of compartments, resulting in small bins for each objective function.

Pareto frontier visualization processing system 10 determines which of the objective functions will be placed on which of the two axes in a two-dimensional representation. For multi-optimization function problems with more than three objective functions, the Pareto frontier visualization processing system 10 determines which functions will be concatenated for counting purposes along which axes (i.e. F₁, F₂, F₃ might be counted and indexed for subsequent representation along the ‘X’ axis, while F₄, F₅, and F₆ might be counted and indexed for representation along the ‘Y’ axis, thereby resulting in a two-dimensional visualization for a 6-F performance space).

The Pareto frontier visualization processing system 10 plots the indices of the bins created on one of the axes. For the example with the two objective function problem, explained earlier with reference to FIGS. 4 and 5, the Pareto frontier visualization processing system 10 places the F₁ bin indices on one axis and the F₂ bin indices on the other axis.

Each point from the design space will have a function value associated for each of the objective functions, which would fall under some combination of these bins that are plotted by the Pareto frontier visualization processing system 10 using their indices on the X and Y axes. The points can be represented as a unit cylinder along the vertical axis.

The results for the exemplary two objective function problem are illustrated in FIGS. 6A, 6B, 7A, and 7B. A grid of 10 was created by the Pareto frontier visualization processing system 10 along all the dimensions, in this example design variables X₁ through X₄. Objective function values were evaluated by the Pareto frontier visualization processing system 10 at all the grid points. All the feasible points were compared by the Pareto frontier visualization processing system 10 to enumerate the non-dominated points. For validation purposes, a number of Pareto points were also generated using Microsoft Excel's optimizer. The blue points in the following FIGS. 6A, 6B, 7A, and 7B represent the non-dominated points for the problem and the black points represent Pareto points.

Referring to FIGS. 6A and 6B, the resulting non-dominated points (from the original discretized design space), together with Pareto points, where each ‘point’ is actually a bin that represents some range determined by the Pareto frontier visualization processing system 10 are illustrated. The discretization by the Pareto frontier visualization processing system 10 for each objective function in this example is twenty, with the non-dominated blue points falling in lower indices bins. This is what would normally be expected since the non-dominated points have a low objective function value for at least one of the objective functions.

Referring to FIGS. 7A and 7B, another example of the same problem address by the Pareto frontier visualization processing system 10 with more refined bins, i.e. fifty along each objective function in this example, is illustrated. It can readily be seen that non-dominated points approximate a Pareto curve by falling towards the low objective function valued bins. This representation is clearly analogous to the normal Pareto frontier representation seen before.

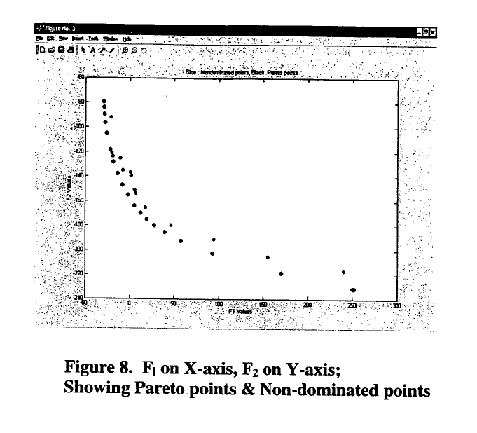

Referring to FIG. 8, the true Pareto points (in black) for the exemplary problem being discussed together with the non-dominated points (in blue) obtained from the grid evaluation in the design space, in a normal XY coordinate representation by the Pareto frontier visualization processing system 10 are illustrated.

As shown in FIGS. 7A, 7B, and 8, the larger the number of bins created by the Pareto frontier visualization processing system 10, the better the shape for the Pareto frontier (shown as blue dots). The division of the objective functions for an optimum number of bins along each can also be determined by the Pareto frontier visualization processing system 10.

Additionally, as shown in FIG. 7B, the vertical axis or z-axis shows the occurrence of the number of points in some combination of these bins, so that one can readily see the areas where a greater number of Pareto points (or even the non-dominated points) are concentrated. This can be critical and helpful for the designers using the Pareto frontier visualization processing system 10 in providing an output that can be used to make design decisions or at least in suggesting areas deserving further exploration.

By way of example, a four objective function problem to show how the HSDC is implemented with the present invention to generate a Pareto front representation for problems with more than three objective functions is discussed below. Consider a four objective function optimization problem below:

$$Minimize : \\ \begin{matrix}{f}_{1} = \frac{{( {X}_{1} - 2 )}^{2}}{2} + \frac{{( {X}_{2} + 1 )}^{2}}{13} + 3 \\ {f}_{2} = \frac{{( {X}_{1} + {X}_{2} - 3 )}^{2}}{175} + \frac{{( 2 {X}_{2} - {X}_{1} )}^{2}}{17} - 13 \\ {f}_{3} = \frac{{( 3 {X}_{1} - 2 {X}_{2} + 4 )}^{2}}{8} + \frac{{( {X}_{1} - {X}_{2} + 1 )}^{2}}{27} + 15 \\ {f}_{4} = \frac{{( 3 {X}_{1} - 2 {X}_{2} + 9 )}^{2}}{34} + \frac{{( {X}_{1} + 1 )}^{2}}{15} + 29\end{matrix}$$

$$Subjected to : \\ \begin{matrix}{g}_{1} = 4 {X}_{1} + {X}_{2} - 4 \leq 0 \\ {g}_{2} = - 1 - {X}_{1} \leq 0 \\ {g}_{3} = {X}_{1} - {X}_{2} - 2 \leq 0 \\ Where : - 4 \leq {X}_{1} , {X}_{2} \leq 4\end{matrix}$$

A grid is created in the design space by the Pareto frontier visualization processing system 10 in the same manner as described with the previous problem. Next, function values for all of the objective functions are evaluated by the Pareto frontier visualization processing system 10 at each of the grid points. Maximum and minimum values for each objective function are calculated by the Pareto frontier visualization processing system 10 to determine the ranges for each objective function. The ranges obtained are then divided to form the bins by the Pareto frontier visualization processing system 10 in the same manner as described with the previous problem. While creating bins for the various objective functions, indices also are associated with increasing order of their values by the Pareto frontier visualization processing system 10.

Next, the Pareto frontier visualization processing system 10 applies the HSDC on the indexes of the objective bins to collapse the four objective functions onto the horizontal plane, two each on the X and Y axes, respectively. Eventually, each index on the X and Y axes would be associated with a combination the indices of the bins of two objective functions using HSDC by the Pareto frontier visualization processing system 10. As a result, a point in the indexed XY space represents some combination of bins from different objective functions, one bin from each.

With the present invention there can be as many objective functions on one axis as needed by creating a path through the indices of the bins created for each objective function. As already shown in previous sections, a path can be created through the indices of an n-dimensional space and map them to a line using HSDC.

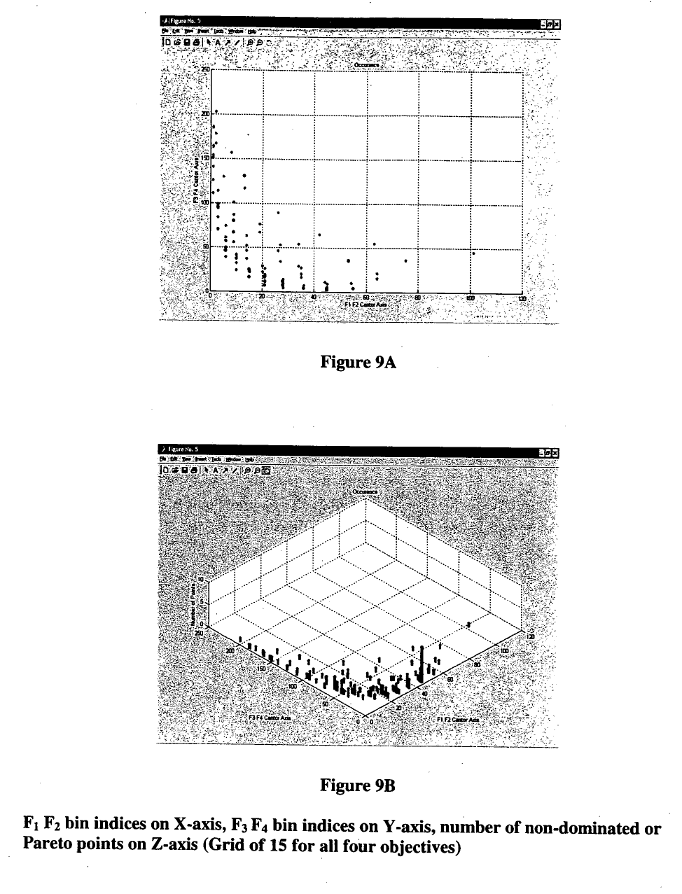

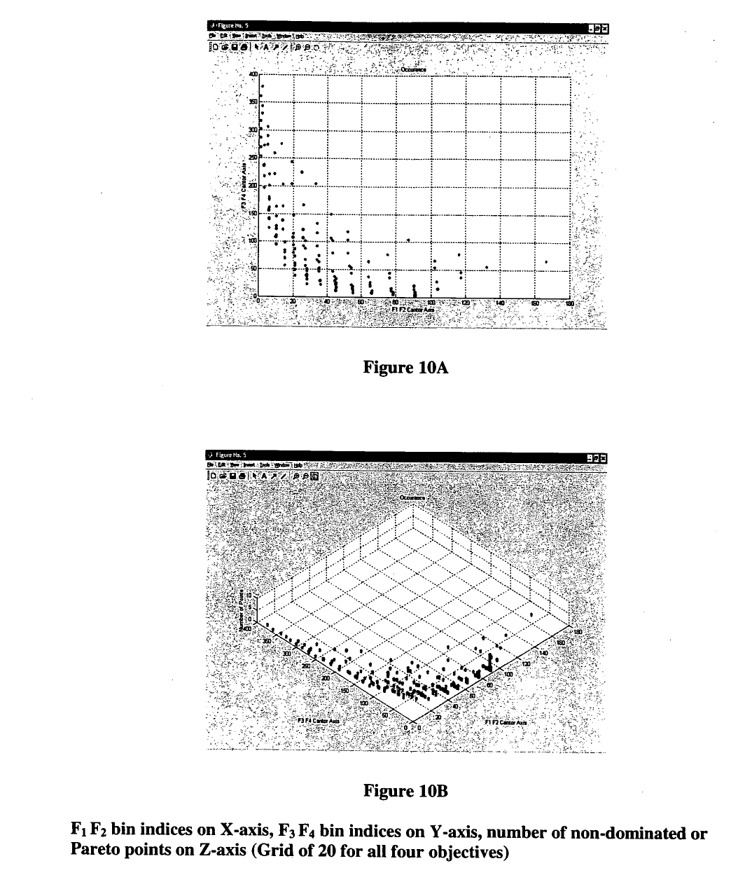

Referring to FIGS. 9A and 9B and FIGS. 10A and 10B, the performance space plot output by the Pareto frontier visualization processing system 10 for the above four objective function problems using the HSDC are illustrated. The non-dominated points (in blue) form some sort of clustered curve in the indexed performance space. Additionally, the Pareto points (in black) are laid out forming an equivalent representation of the Pareto front, which is highly intuitive. This is because of the way the indices of the bins have been collapsed to form the indices along the X and Y directions. All the bins with low objective function ranges are mapped to the lower indices on the X and Y axes.

Generally, the greater the number of bins along the objective functions, the better the distribution of non-dominated or Pareto points along the indexed performance space. However, there is always a tradeoff in having more and more numbers of bins, as the values of the non-dominated and Pareto points would need to be compared with more and more numbers of ranges of these bins, which adds to the computational costs for the Pareto frontier visualization processing system 10.

As illustrated in FIGS. 9A and 9B, one of the black bins stands alone, i.e. has the maximum height, which shows that there are six Pareto points (out of the fifty points generated for this problem) occurring simultaneously in that particular combination of F₁, F₂, F₃, and F₄ bins. This grouping and other similar groupings can be identified and output by the Pareto frontier visualization processing system 10. This output from the Pareto frontier visualization processing system 10 can be extremely useful when it comes time for the designer to articulate his preference amongst possible Pareto solutions. Moreover, if such results are preferred for a decision, the Pareto frontier visualization processing system 10 can be used to easily trace back many available options for the design points in the design space and output those to the operator.

Another method for Pareto front visualization in accordance with other embodiments of the present invention will now be described with reference to FIGS. This method pertains to representing the Pareto frontier for multi-objective function problems (necessitating obtaining many optimal solutions using an optimizer. This method is much simpler because only the optimized results are represented, thereby visualizing the Pareto frontier directly.

The Pareto frontier visualization processing system 10 performs some number of optimizations from different initial points, resulting in an optimal value for each of the objective functions and constraints, for problems with constraints. The minimum and maximum values for each of the objective functions are identified by the Pareto frontier visualization processing system 10 to establish a range. The Pareto frontier visualization processing system 10 divides these ranges into some finite number of compartments, resulting in small bins for each of the objective functions.

The Pareto frontier visualization processing system 10 determine which of the objective functions will be placed on which of the axes in a two-dimensional representation, e.g. the X-axis and Y-axis. For multiobjective optimization problems with more than three objective functions, the Pareto frontier visualization processing system 10 determines which functions will be concatenated for counting purposes along which axes (i.e. F₁, F₂, F₃ might be counted and indexed for subsequent representation along the ‘X’ axis, while F₄, F₅, and F₆ might be counted and indexed for representation along the ‘Y’ axis, thereby resulting in a two-dimensional visualization for a six function performance space).

The Pareto frontier visualization processing system 10 plots the indices of the bins created on one of the axes. For the example with the two objective function problem, explained earlier with reference to FIGS. 4 and 5, the Pareto frontier visualization processing system 10 places the F₁ bin indices on one axis and the F₂ bin indices on the other axis.

Each point from the design space will have a function value associated for each of the objective functions, which would fall under some combination of these bins that are plotted by the Pareto frontier visualization processing system 10 using their indices on the X and Y axes. The points can be represented as a unit cylinder along the vertical axis.

Referring to FIGS. 8 and 10A and 10B, the black bins, which represent the Pareto frontier for a two function and four function problem, respectively, are illustrated. The ability to output the Pareto frontier for more than three functions in such an intuitive and easily understandable manner is extremely useful to designers in numerous industries and for numerous applications.

Accordingly, as described above, the present invention can be used to visualize n-dimensional Pareto points generated as a result of optimization and can be used to visualize the non-dominated points in an n-dimensional grid of the performance space and hence the Pareto front can be estimated very quickly. The present invention can be used to visually represent datasets of virtually unlimited dimensionality. With the present invention, the user can choose which dimensions to blend to which axis and can choose successively finer granularities to discretize the data with for a finer detailed perspective. Further, the present invention allows intuitive observation and discovery at a level that is far more amenable to human perception. The present invention also takes high dimensional data and puts it into a two-dimensional or three-dimensional space, allowing analysis in a far more comfortable format.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for visually representing a Pareto frontier, the method comprising:
performing two or more optimizations from different initial points to obtain optimal values for each of two or more objective functions;
identifying a minimum value and a maximum value from the optimal values for each of the objective functions to establish a range for each of the objective functions;
dividing each of the ranges into a first number of bins for each of the objective functions;
determining which of the objective functions will be placed on which of at least two axes;
plotting indices of the bins along the determined of the at least two axes for each of the objective functions; and
outputting the plotted indices which represent the Pareto frontier for the objective functions along the at least two axes.

2. The method as set forth in claim 1 wherein the determining further comprises determining when there are three or more of the objective functions which of the three or more objective functions will be concatenated along which of the two axes.

3. The method as set forth in claim 1 wherein the outputting outputs the plotted indices along three axes.

4. The method as set forth in claim 3 further comprising identifying one or more of the one or more of the bins with multiple plotted indices, wherein the outputting outputs the identified one or more bins.

5. The method as set forth in claim 1 wherein the performing further comprises performing two or more optimizations from the different initial points to obtain optimal values for each of one or more constraints;
wherein the identifying a minimum value and a maximum value further comprises identifying a minimum value and a maximum value from the optimal values for each of the one or more constraints to establish a range for each of the one or more constraints;
wherein the dividing each of the ranges further comprises dividing each of the ranges into a first number of bins for each of the one or more constraints;
wherein the determining further comprises determining which of the one or more constraints will be placed on which of the at least two axes;
wherein the plotting indices further comprises plotting the indices of the bins along the determined of the at least two axes for each of the one or more constraints; and
wherein the outputting further comprises outputting the plotted indices which represent the Pareto frontier for the objective functions and the one or more constraints along the at least two axes.

6. A system for visually representing a Pareto frontier, the system comprising:
an optimization system in at least one computing device that performs two or more optimizations from different initial points to obtain optimal values for each of two or more objective functions;
an identification system that identifies a minimum value and a maximum value from the optimal values for each of the objective functions to establish a range for each of the objective functions;
a dividing system that divides each of the ranges into a first number of bins for each of the objective functions;
a determination system that determines which of the objective functions will be placed on which of at least two axes;
a plotting system that plots indices of the bins along the determined one of the at least two axes axis for each of the objective functions; and
at least one output device that outputs the plotted indices which represent the Pareto frontier for the objective functions along the at least two axes.

7. The system as set forth in claim 6 wherein the determination system determines when there are three or more of the objective functions which of the three or more objective functions will be concatenated along which of the two axes.

8. The system as set forth in claim 6 wherein the at least one output device outputs the plotted indices along three axes.

9. The system as set forth in claim 8 further comprising another identification system that identifies one or more of the one or more of the bins with multiple plotted indices from plotted indices, wherein the output device outputs the identified one or more bins.

10. The system as set forth in claim 7 wherein the optimization system performs two or more optimizations from the different initial points to obtain optimal values for each of one or more constraints;
wherein the identification system identifies a minimum value and a maximum value from the optimal values for each of the one or more constraints to establish a range for each of the one or more constraints;
wherein the dividing system divides each of the ranges into a first number of bins for each of the one or more constraints;
wherein the determination system determines which of the one or more constraints will be placed on which of the at least two axes;
wherein the plotting system plots the indices of the bins along the determined of the at least two axes for each of the one or more constraints; and
wherein the output device outputs the plotted indices which represent the Pareto frontier for the objective functions and the one or more constraints along the at least two axes.

11. A method for visually non-dominated points representing a Pareto frontier, the method comprising:
discretizing a design space for a first number of divisions along a plurality of design variables to form a grid;
analyzing each point in the grid in a two or more dimensional space to provide a value for each of a plurality of objective functions;
identifying a minimum value and a maximum value from the optimal values for each of the objective functions to establish a range for each of the objective functions;
dividing each of the ranges into a first number of bins for each of the objective functions;
determining which of the objective functions will be placed on which of the at least two axes;
plotting indices of the bins along the determined one of the at least two axes for each of the objective functions; and
outputting the plotted indices which represent non-dominated points representing a Pareto frontier for the objective functions along the at least two axes.

12. The method as set forth in claim 11 wherein the determining further comprises determining when there are three or more of the objective functions which of the three or more objective functions will be concatenated along which of the two axes.

13. The method as set forth in claim 111 wherein the outputting outputs the plotted indices along three axes.

14. The method as set forth in claim 13 further comprising identifying one or more of the one or more of the bins with multiple plotted indices, wherein the outputting outputs the identified one or more bins.

15. The method as set forth in claim 11 wherein the analyzing further comprises analyzing each point in the grid in the two or more dimensional space to provide a value for each of one or more constraints;
wherein the identifying a minimum value and a maximum value further comprises identifying a minimum value and a maximum value from the optimal values for each of the one or more constraints to establish a range for each of the one or more constraints;
wherein the dividing each of the ranges further comprises dividing each of the ranges into a first number of bins for each of the one or more constraints;
wherein the determining further comprises determining which of the one or more constraints will be placed on which of the at least two axes;
wherein the plotting indices further comprises plotting the indices of the bins along the determined of the at least two axes for each of the one or more constraints; and
wherein the outputting further comprises outputting the plotted indices which represent the Pareto frontier for the objective functions and the one or more constraints along the at least two axes.

16. A system for visually representing a Pareto frontier, the system comprising:
discretizing system in a computing device that discretizes a design space for a first number of divisions along a plurality of design variables to form a grid;
an analysis system that analyzes each point in the grid in a two or more dimensional space to provide a value for each of a plurality of objective functions;
an identification system that identifies a minimum value and a maximum value from the optimal values for each of the objective functions to establish a range for each of the objective functions;
a dividing system that divides each of the ranges into a first number of bins for each of the objective functions;
a determination system that determines which of the objective functions will be placed on which of at least two axes;
a plotting system that plots indices of the bins along the determined one of the at least two axes axis for each of the objective functions; and
at least one output device that outputs the plotted indices which represent the Pareto frontier for the objective functions along the at least two axes.

17. The system as set forth in claim 16 wherein the determination system determines when there are three or more of the objective functions which of the three or more objective functions will be concatenated along which of the two axes.

18. The system as set forth in claim 16 wherein the at least one output device outputs the plotted indices along three axes.

19. The system as set forth in claim 18 further comprising another identification system that identifies one or more of the one or more of the bins with multiple plotted indices from plotted indices, wherein the output device outputs the identified one or more bins.

20. The system as set forth in claim 16 wherein the analysis system analyzes each point in the grid in n dimensional space to provide a value for each of one or more constraints;
wherein the identification system identifies a minimum value and a maximum value from the optimal values for each of the one or more constraints to establish a range for each of the one or more constraints;
wherein the dividing system divides each of the ranges into a first number of bins for each of the one or more constraints;
wherein the determination system determines which of the one or more constraints will be placed on which of the at least two axes;
wherein the plotting system plots the indices of the bins along the determined of the at least two axes for each of the one or more constraints; and
wherein the output device outputs the plotted indices which represent the Pareto frontier for the objective functions and the one or more constraints along the at least two axes.
